(19) United States
(12) Patent Application Publication
(10) Pub. No.: US 2025/0167488 A1
(43) Pub. Date: May 22, 2025

(54) CONNECTOR

(71) Applicant: SUMITOMO WIRING SYSTEMS, LTD., Mie (JP)

(72) Inventor: Yuichi OTO, Mie (JP)

(21) Appl. No.: 18/944,611

(22) Filed: Nov. 12, 2024

(30) Foreign Application Priority Data
Nov. 21, 2023 (JP) 2023-197322

(51) Int. Cl. H01R 13/627

(52) U.S. Cl. CPC H01R 13/6271

(57) ABSTRACT

A connector 10 includes a housing 20 connectable to a mating connector 100. The housing 20 includes a plurality of cavities 23 capable of accommodating terminal fittings 90. The respective cavities are arranged side by side in a width direction intersecting a connection direction of the housing 20 and the mating connector 100 inside the housing 20. The housing 20 includes a central side lock portion 35 located on a central side in the width direction for holding a connected state to the mating connector 100 and end side lock portions 36 located on both end sides in the width direction for holding the connected state to the mating connector 100.

### CROSS-REFERENCE TO RELATED APPLICATIONS

This application is based on and claims priority from Japanese Patent Application No. 2023-197322, filed on Nov. 21, 2023, with the Japan Patent Office, the disclosure of which is incorporated herein in its entirety by reference.

### TECHNICAL FIELD

The present disclosure relates to a connector.

### BACKGROUND

Japanese Patent Laid-open Publication No. 2004-134190 discloses a technique for fastening a pair of connector housings to each other by a nut member.

Japanese Patent Laid-open Publication No. 2015-201331 discloses a connector provided with a first housing and a second housing connectable to each other. First terminal fittings are accommodated in the first housing. The first housing is formed with a resiliently deformable lock arm. Second terminal fittings connectable to the first terminal fittings are accommodated in the second housing. The second housing is formed with a lock portion lockable to the lock arm. By locking the lock portion to the lock arm, the first and second housings are held in a connected state.

Japanese Patent Laid-open Publication No. 2011-086478 discloses a moving plate to be arranged movably inside a male connector. Similarly, Japanese Patent Laid-open Publication No. 2014-241253 discloses a moving plate to be arranged movably inside a receptacle.

### SUMMARY

The technique disclosed in Japanese Patent Laid-open Publication No. 2004-134190 has a number of structural limitations and lacks versatility due to situations such as the mounting of the nut member into the housing. In contrast, a technique disclosed in Japanese Patent Laid-open Publication No. 2015-201331 is a general structure of locking the lock portion to the lock arm and has high versatility. However, if vibration is applied to the connector when a plurality of wires are pulled out side by side in a width direction from the first housing, each pulled-out wire may shake in the width direction with a locked part of the lock arm and the lock portion (widthwise central part of the first housing) as a fulcrum. If each wire shakes in the width direction, the first and second housings may rattle in the range of a mutual fitting gap (clearance) and the first and second terminal fittings may slide relative to each other and be worn.

Accordingly, the present disclosure aims to provide a connector capable of preventing a terminal fitting from being worn when vibration is applied to a wire.

The present disclosure is directed to a connector with a housing connectable to a mating connector, the housing including a plurality of cavities capable of accommodating terminal fittings, the plurality of cavities being arranged side by side in a width direction intersecting a connection direction of the housing and the mating connector inside the housing, and the housing including a central side lock portion located on a central side in the width direction for holding a connected state to the mating connector and end side lock portions located on both end sides in the width direction for holding the connected state to the mating connector.

According to the present disclosure, it is possible to provide a connector capable of preventing a terminal fitting from being worn when vibration is applied to a wire.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view of a connector of one embodiment showing a state where a housing and a mating connector are held in a connected state.

FIG. 2 is a section along A-A of FIG. 1 of the connector of the embodiment.

FIG. 3 is a section along B-B of FIG. 1 of the connector of the embodiment.

FIG. 4 is a section along C-C of FIG. 1 of the connector of the embodiment.

FIG. 5 is a side view in section enlargedly showing a part cut at a position where a plate lock portion locks a plate locked portion in the connector of the embodiment.

FIG. 6 is a side view in section of the connector of the embodiment showing a state where a moving plate is held at a protection position with respect to a housing.

FIG. 7 is a front view of a mating connector as a connection partner of the connector of the first embodiment.

FIG. 8 is a front view of the housing in the connector of the embodiment.

FIG. 9 is a plan view of the moving plate in the connector of the embodiment.

FIG. 10 is a front view of the moving plate in the connector of the embodiment.

FIG. 11 is a back view of the moving plate in the connector of the embodiment.

FIG. 12 is an exploded perspective view of the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Embodiments of the present disclosure are first listed and described.

(1) The connector of the present disclosure is provided with a housing connectable to a mating connector, the housing including a plurality of cavities capable of accommodating terminal fittings, the plurality of cavities being arranged side by side in a width direction intersecting a connection direction of the housing and the mating connector inside the housing, and the housing including a central side lock portion located on a central side in the width direction for holding a connected state to the mating connector and end side lock portions located on both end sides in the width direction for holding the connected state to the mating connector.

According to the configuration of (1) described above, since a vibration force can be partially absorbed by the end side lock portions located on the both widthwise end sides of the housing when vibration is applied to the connector in the width direction, it can be avoided that the central side lock portion becomes a shaking fulcrum of the housing. In this way, the connected state of the housing and the mating connector can be held without rattling by the interaction of the central side lock portion and the end side lock portions.

(2) Preferably, in the connector of (1) described above, the central side lock portion and a central side locked portion serving as a locking partner of the central side lock portion are locked while being restricted from moving in the width direction, and the end side lock portions and end side locked portions serving as locking partners of the end side lock portions are locked while being restricted from moving in the width direction.

According to the configuration of (2) described above, the rattling of the housing in the width direction with respect to the mating connector can be more reliably suppressed.

(3) In the connector of (1) or (2) described above, the end side locked portions may be provided on a moving plate to be arranged movably inside a receptacle of the housing, and the moving plate may include a plate lock portion to be locked to the mating connector when the housing and the mating connector are in the connected state, separately from the end side locked portions.

According to the configuration of (3) described above, the mating connector is locked to the moving plate by the plate lock portion and can be held in the connected state to the housing via the end side locked portions of the moving plate. Thus, structures equivalent to the end side locked portions can be omitted from the mating connector and the complication of the structure of the mating connector can be avoided.

(4) In the connector of (3) described above, a plurality of the plate lock portions may be arranged at intervals in the width direction in the moving plate.

According to the configuration of (4) described above, the rattling of the mating connector in the width direction with respect to the moving plate can be suppressed, and a function of suppressing the rattling of the housing with respect to the mating connector can be ensured.

(5) In the connector of any one of (1) to (4) described above, the housing may have a wire pull-out surface arranged to face rearward in a direction opposite to the connection direction to the mating connector and wires connected to the terminal fittings are pulled out rearward from the wire pull-out surface, and the end side lock portions may be arranged behind the central side lock portion.

According to the configuration of (5) described above, when each wire pulled out from the wire pull-out surface of the housing shakes in the width direction, the end side lock portions located near each pull-out wire can more efficiently receive the vibration of each wire than the central side lock portion. As a result, the rattling of the housing in the width direction with respect to the mating connector can be even more reliably suppressed.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

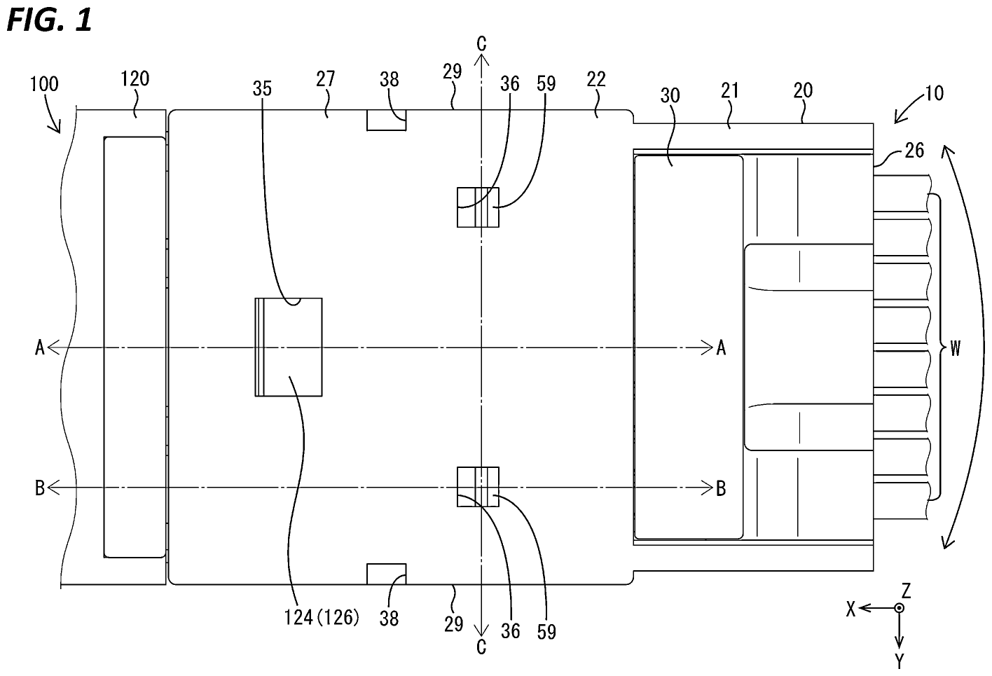

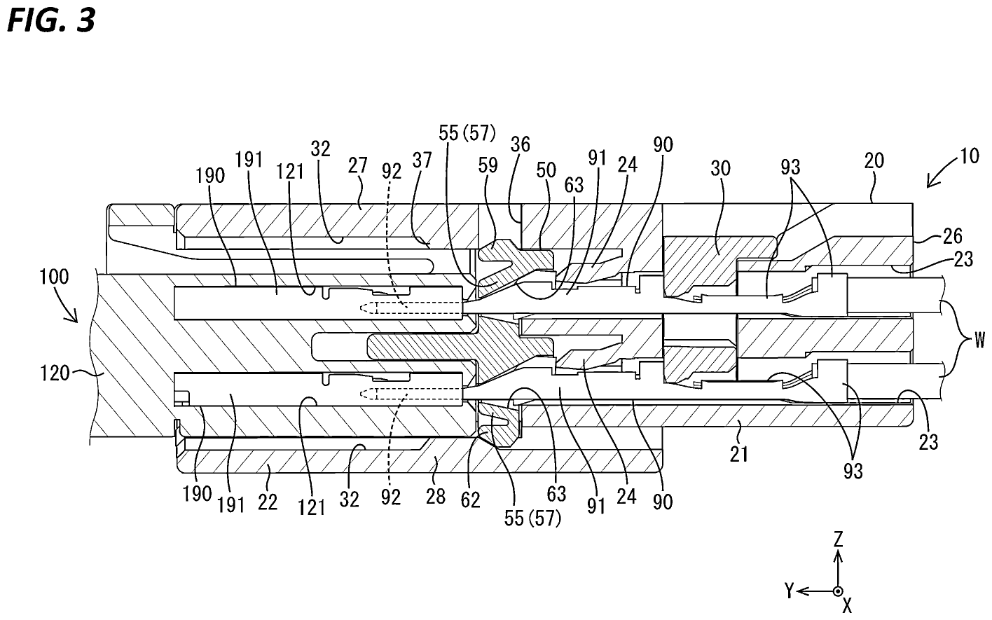

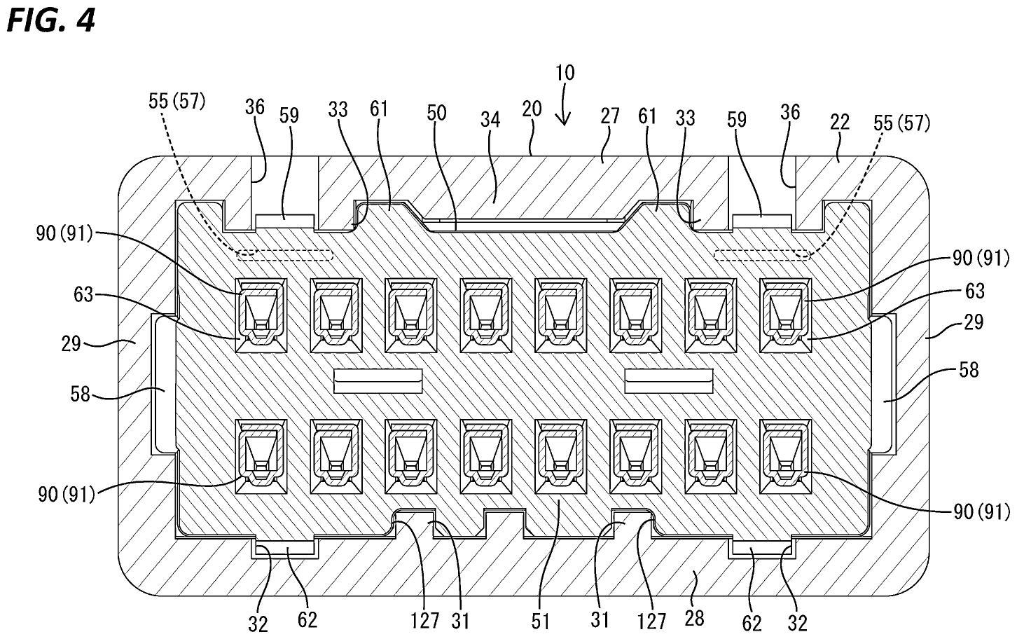

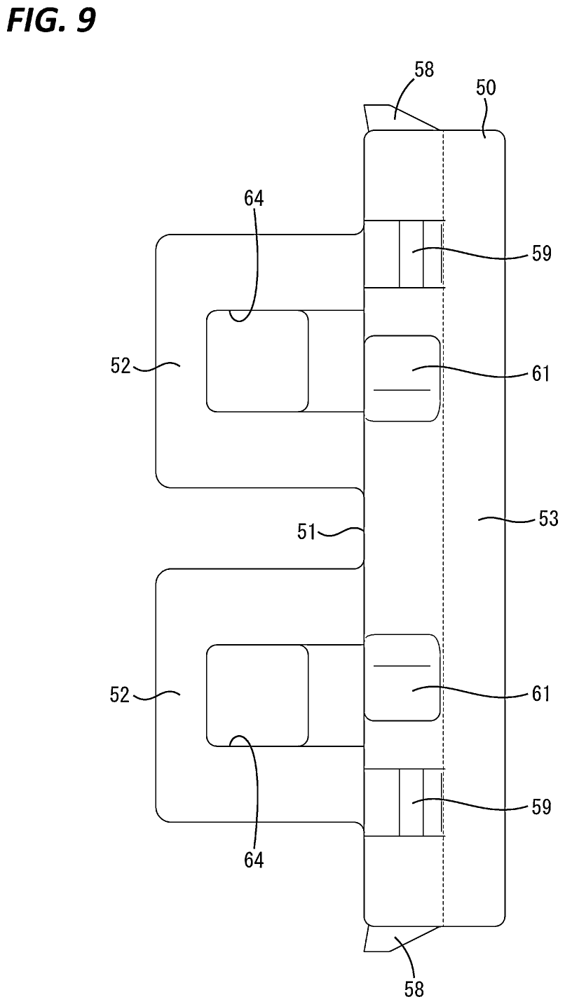

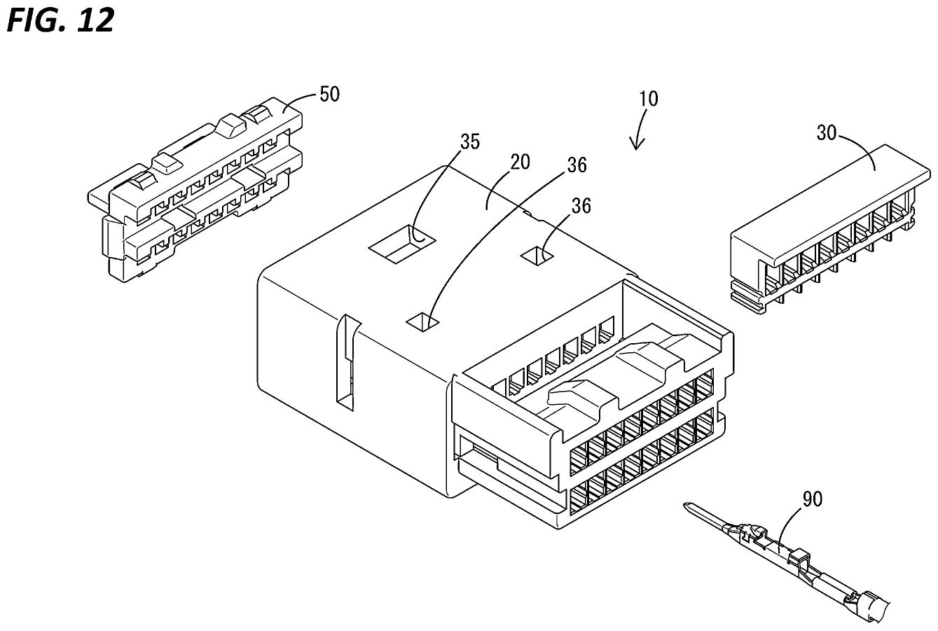

A connector 10 of an embodiment is provided with a housing 20 and a moving plate 50 to be movably mounted into the housing 20 as shown in FIG. 12. As shown in FIG. 3, the housing 20 is connectable to a mating connector 100. Terminal fittings 90 are accommodated inside the housing 20. Note that, in the following description, facing directions of the connector 10 and the mating connector 100 when the connection of the connector 10 and the mating connector 100 is started (directions facing mating sides) are referred to as forward directions concerning a front-rear direction. A vertical direction is based on a vertical direction of each figure except FIGS. 1 and 9. The vertical direction may be called a height direction. A lateral direction is based on a lateral direction of FIGS. 4, 7, 8, 10 and 11. The lateral direction is called a width direction. These direction references do not necessarily coincide with direction references in a state where the connector 10 is installed in an unillustrated vehicle or the like. In FIGS. 1 to 3, a forward direction, a rightward direction and an upward direction based on the connector 10 are indicated by X, Y and Z.

### Mating Connector 100

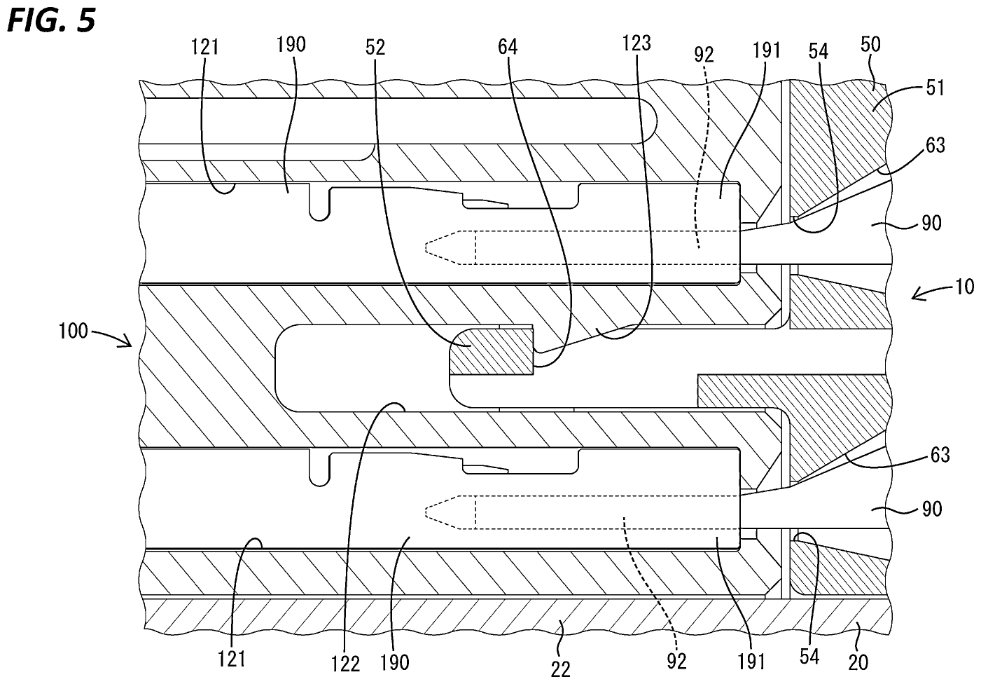

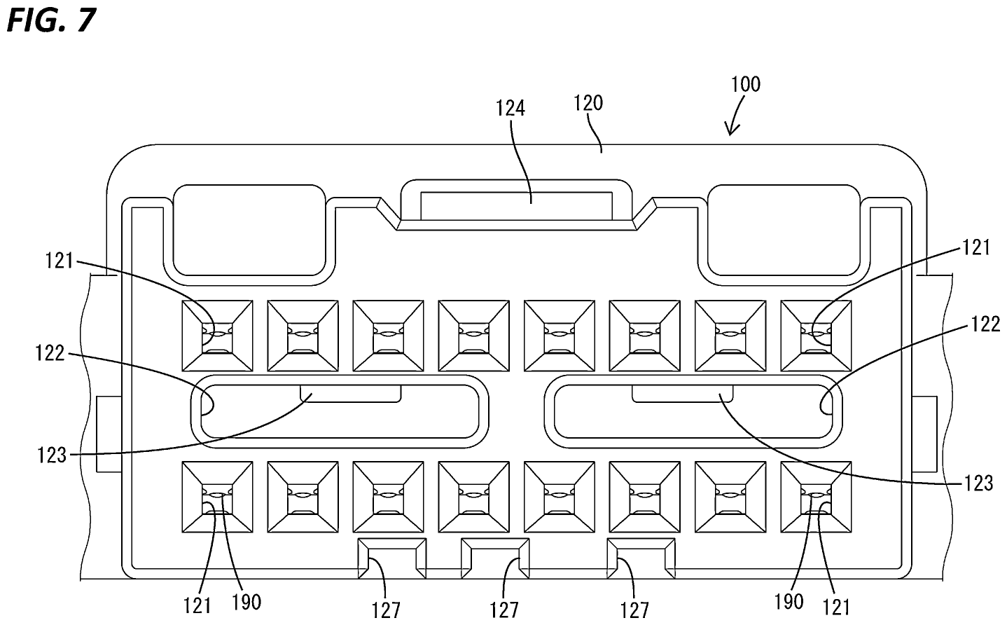

The mating connector 100 is a female connector and provided with a mating housing 120 serving as a female housing. The mating housing 120 is made of synthetic resin and in the form of a rectangular block. As shown in FIG. 7, the mating housing 120 is formed with a plurality of mating cavities 121. A plurality of the mating cavities 121 are arranged in the width direction in a plurality of stages in the height direction, in two upper and lower stages in the case of this embodiment, inside the mating housing 120. The mating housing 120 includes a pair of plate lock receiving portions 122 in the width direction between the upper and lower mating cavities 121. Each plate lock receiving portion 122 is in the shape of an opening extending long in the width direction in the front surface of the mating housing 120. Further, each plate lock receiving portion 122 is shaped to be recessed deep rearward from the front surface of the mating housing 120. The upper surface (surface facing down) and the lower surface (surface facing up) of the inner wall of each plate lock receiving portion 122 are flat surfaces along the lateral direction and arranged in parallel to each other. The mating housing 120 includes plate locked portions 123 projecting from the upper surfaces of the inner walls of the respective plate lock receiving portions 122. Each plate locked portion 123 has a rectangular shape long in the lateral direction. As shown in FIG. 5, the front surface of the plate locked portion 123 is inclined rearward. The rear surface of the plate locked portion 123 is rising in the vertical direction. Later-described plate lock portions 52 of the moving plate 50 are facing and lockable to the rear surfaces of the plate locked portions 123.

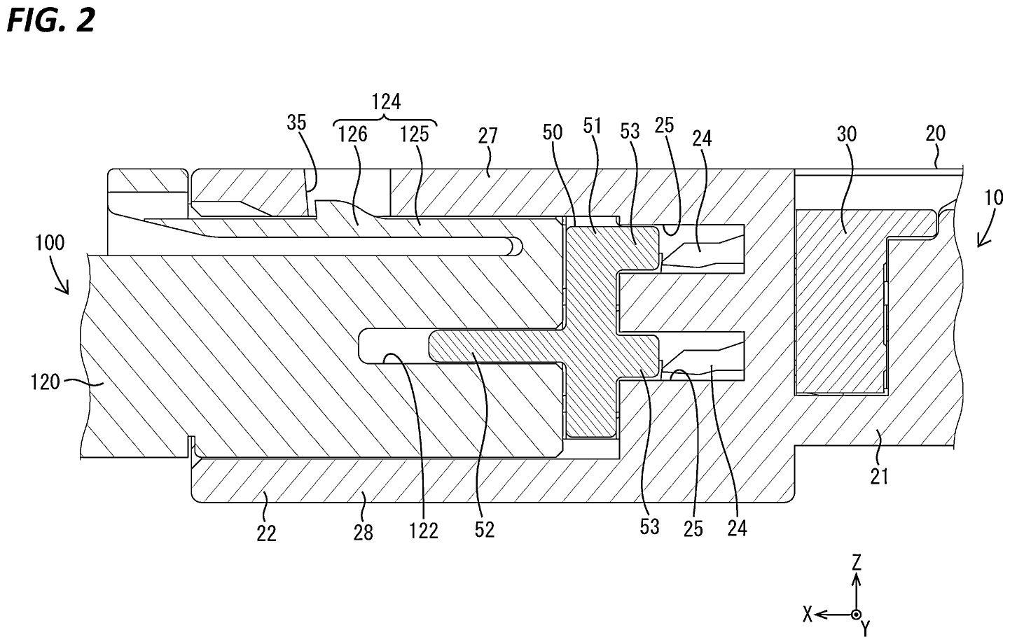

As shown in FIG. 7, a central side locked portion 124 is formed to project in a lateral central part of the upper surface of the mating housing 120. The central side locked portion 124 is a so-called lock arm and includes, as shown in FIG. 2, a resiliently deformable arm portion 125 extending rearward after rising from the front end of the upper surface of the mating housing 120 and a lock projection 126 projecting upward from a central part in the front-rear direction of the arm portion 125. The lock projection 126 is facing and lockable to a later-described central side lock portion 35 of the housing 20. As shown in FIG. 7, a plurality of erroneous connection preventing recesses 127 are formed in the lower surface of the mating housing 120. As shown in FIG. 4, the respective erroneously connection preventing recesses 27 are fittable to later-described erroneously connection preventing protrusions 31 of the housing 20.

As shown in FIGS. 3 and 5, mating terminal fittings 190 are inserted and accommodated into the mating cavities 121 of the mating housing 120 from behind. The mating terminal fitting 190 is made of electrically conductive metal and includes a tubular connecting portion 191. With the mating housing 120 fit in the housing 20, a later-described tab 92 of the terminal fitting 90 is inserted into the connecting portion 191 and the terminal fitting 90 and the mating terminal fitting 190 are electrically connected. A rear part of the mating terminal fitting 190 is soldered and electrically connected to an unillustrated circuit board.

### Housing 20 and Terminal Fittings 90

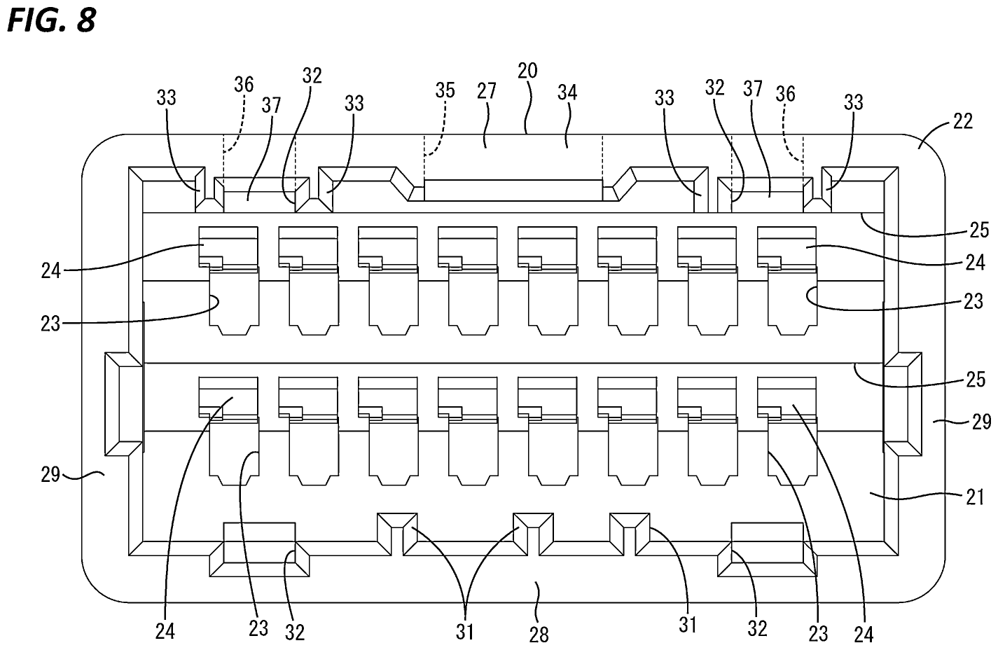

The housing 20 is made of synthetic resin and, as shown in FIG. 8, has a laterally long shape having a width in the lateral direction larger than a height in the vertical direction as a whole. The housing 20 includes a housing body 21 in the form of a rectangular block and a receptacle 22 in the form of a rectangular tube projecting forward from the housing body 21. As shown in FIGS. 2 and 3, the mating housing 120 is fit into the receptacle 22.

As shown in FIG. 8, the housing body 21 is formed with a plurality of cavities 23. A plurality of the cavities 23 are arranged in the width direction in a plurality of stages in the height direction, in two upper and lower stages in the case of this embodiment, inside the housing body 21 to correspond to the respective mating cavities 121. A resiliently deformable locking lance 24 is formed to project on the upper surface (surface facing down) of the inner wall of each cavity 23. A pair of recesses 25 are formed in the front surface of the housing body 21 (also the back surface of the receptacle 22) while being spaced apart in the vertical direction. Each recess 25 is provided over the entire width in the lateral direction in the front surface of the housing body 21. Each locking lance 24 is exposed to be visually confirmable through the recess 25.

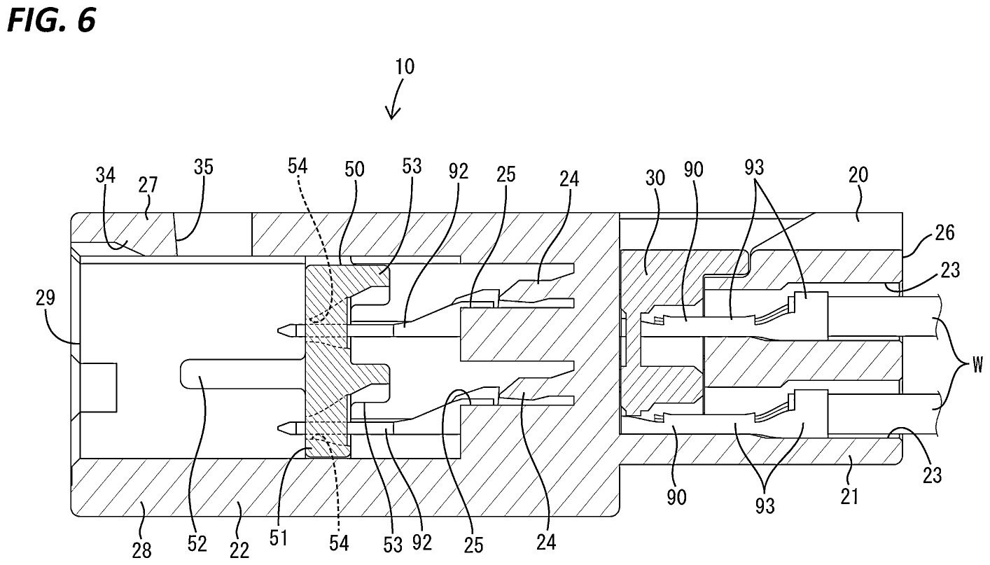

The terminal fitting 90 is made of electrically conductive metal and configured as a male terminal. As shown in FIG. 3, the terminal fitting 90 includes a tubular terminal body 91, the tab 92 projecting forward from the terminal body 91 and a barrel portion 93 located behind the terminal body 91. The barrel portion 93 is electrically and mechanically connected to an end part of a wire W. The terminal body 91 is locked by the locking lance 24. The terminal fitting 90 is primarily restricted from coming out rearward from the cavity 23 by the locking lance 24. Further, the terminal fitting 90 is also locked by a retainer 30 mounted into the housing body 21, thereby being secondarily restricted from coming out rearward from the cavity 23. As shown in FIG. 6, the tab 92 is arranged to project into the receptacle 22.

The rear end of each cavity 23 is open in the rear surface of the housing body 21. As shown in FIGS. 1 and 3, the rear surface of the housing body 21 is configured as a wire pull-out surface 26, from which the wires W connected to the respective terminal fittings 90 are pulled out. As shown in FIG. 1, the wire pull-out surface 26 is an end surface long in the lateral direction. The respective wires W are pulled out side by side in the lateral direction from the wire pull-out surface 26.

As shown in FIG. 8, the receptacle 22 includes an upper wall 27 and a lower wall 28 facing each other in the vertical direction and a pair of side walls 29 facing each other in the lateral direction. The upper and lower walls 27, 28 are arranged along the lateral direction. Each side wall 29 is arranged along the vertical direction. A plurality of the erroneous connection preventing protrusions 31 are formed on the inner surface of the lower wall 28. If the housing 20 and the mating housing 120 are in proper connection postures, the respective erroneous connection preventing protrusions 31 are fit into the respective erroneous connection preventing recesses 127. If the housing 20 and the mating housing 120 are in wrong connection postures such as by being vertically inverted, the fitting of the respective erroneous connection preventing protrusions 31 into the respective erroneous connection preventing recesses 127 is restricted. In this way, the erroneous connection of the housing 20 and the mating housing 120 is prevented.

As shown in FIG. 8, both left and right end parts of the inner surface of each of the upper and lower walls 27, 28 of the receptacle 22 are recessed to provide the guide portions 32. As shown in FIG. 3, each guide portion 32 extends in the front-rear direction and is open in the front end of the receptacle 22. As shown in FIG. 8, the guide portion 32 of the upper wall 27 is formed between guide ribs 33 facing each other in the lateral direction on the inner surface of the upper wall 27. The guide portion 32 of the upper wall 27 is closed by a rib 37 connecting between the rear ends of the guide portions 32 facing each other in the lateral direction (see FIG. 3).

As shown in FIG. 8, a base portion 34 having a larger thickness in the vertical direction than both left and right end parts of the upper wall 27 is formed in a lateral central part of the upper wall 27 of the receptacle 22. As shown in FIGS. 2 and 6, the upper wall 27 of the receptacle 22 is formed with the central side lock portion 35 penetrating through the base portion 34 in the vertical direction (thickness direction of the upper wall 27). As shown in FIG. 1, the central side lock portion 35 is in the form of a rectangular opening in a plan view at a position in the lateral central part and near the front end of the upper wall 27. Specifically, the central side lock portion 35 is in the form of a laterally long opening having an opening width in the lateral direction larger than an opening length in the front-rear direction. The lock projection 126 of the central side locked portion 124 is fittable into the central side lock portion 35 while being restricted in position in the lateral direction (state where a positional displacement is restricted).

Further, as shown in FIGS. 3 and 4, the upper wall 27 of the receptacle 22 is formed with a pair of end side lock portions 36 penetrating through both left and right end parts of the upper wall 27 in the vertical direction. As shown in FIG. 1, the respective end side lock portions 36 are in the form of nearly square rectangular openings in a plan view at positions in both left and right end parts and near the rear end of the upper wall 27. Specifically, each end side lock portion 36 is in the form of an opening having an opening length in the front-rear direction slightly larger than an opening width in the lateral direction. Further, the respective end side lock portions 36 are arranged behind the respective guide portions 32 of the upper wall 27. As shown in FIG. 3, the front surface (surface located on a front side and facing rearward) of the end side lock portion 36 is defined by the rib 37. A later-described end side locked portion 59 of the moving plate 50 is fittable into the end side lock portion 36 while being restricted in position in the lateral direction.

As shown in FIG. 1, each side wall 29 of the receptacle 22 is formed with a plate locking portion 38 penetrating through the side wall 29 in the lateral direction (thickness direction of the side wall 29). Each plate locking portion 38 is arranged on a central side in the front-rear direction of each side wall 29. Although not shown in detail, each plate locking portion 38 extends in the vertical direction and the upper end thereof is open in the upper surface of the receptacle 22. A later-described plate locked portion 58 of the moving plate 50 is lockable to the plate locking portion 38.

### Moving Plate 50

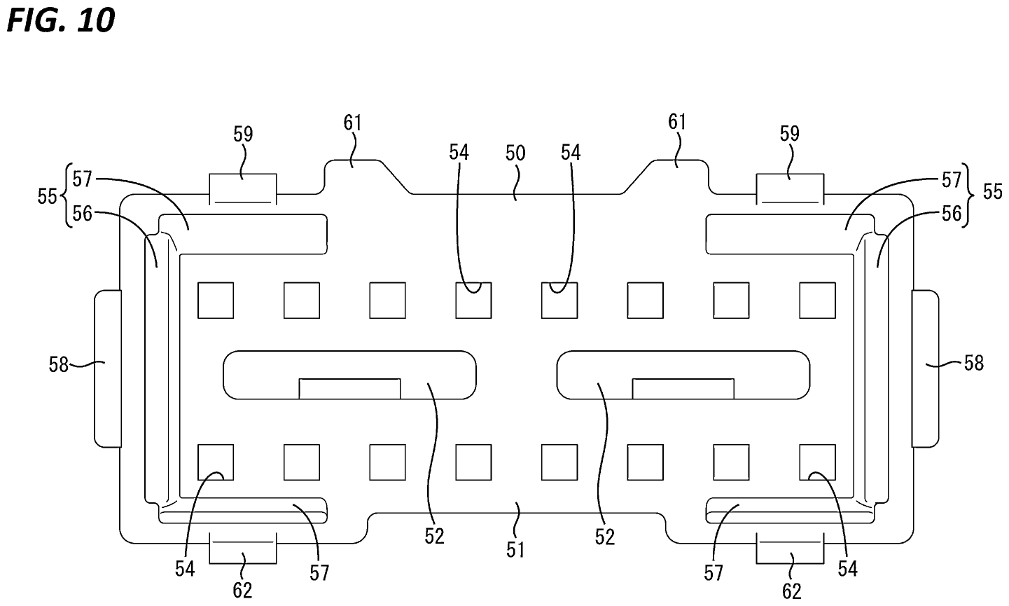

The moving plate 50 is made of synthetic resin and mounted movably between a protection position (see FIG. 6) and a connection position (see FIGS. 2 and 3) with respect to the housing 20. As shown in FIG. 10, the moving plate 50 includes a plate body 51 having a thickness in the front-rear direction and having a rectangular shape in a front view, and a pair of left and right plate lock portions 52 projecting forward from the front surface of the plate body 51. Further, as shown in FIGS. 2 and 6, the moving plate 50 includes a pair of upper and lower protrusions 53 projecting rearward from the rear surface of the plate body 51.

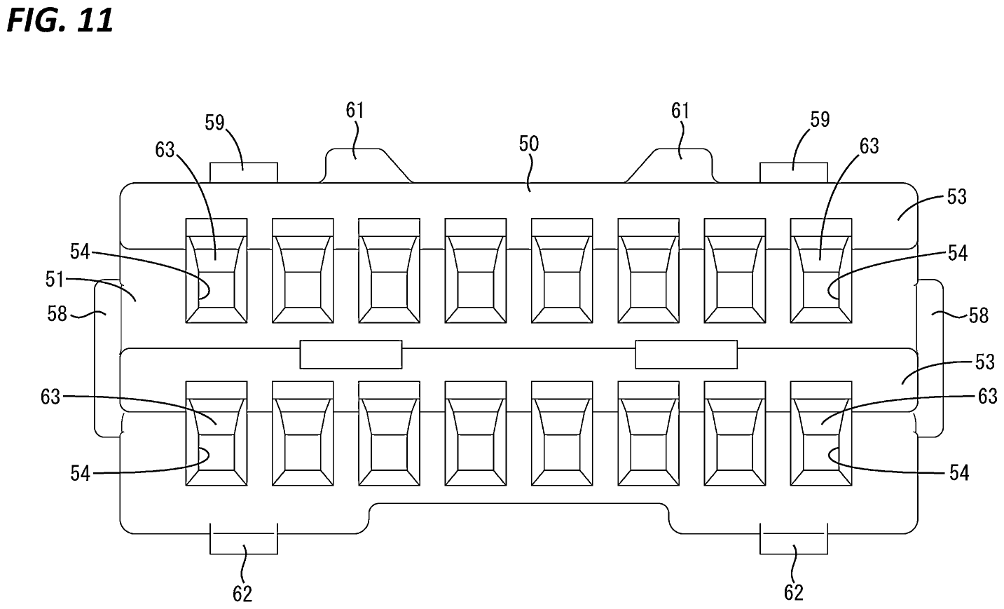

As shown in FIGS. 10 and 11, the plate body 51 is formed with a plurality of insertion holes 54. A plurality of the insertion holes 54 are arranged in the width direction in a plurality of stages in the height direction, in two upper and lower stages in the case of this embodiment, inside the plate body 51 to correspond to the respective cavities 23.

As shown in FIG. 10, each insertion hole 54 is in the form of a square hole in a front view. The tab 92 of each terminal fitting 90 is positioned and inserted into each insertion hole 54 (see FIGS. 5 and 6). As shown in FIG. 10, thin portions 55 thinner than adjacent parts are formed in both left and right end parts of the plate body 51. The thin portion 55 has an angular C shape (angular U shape) in the front view and includes a vertically extending portion 56 extending in the vertical direction in a left or right outer end part of the plate body 51 and laterally extending portions 57 extending laterally inward in end parts on both upper and lower sides of the plate body 51. The thin portion 55 is thinned by recessing corresponding parts (vertically extending portion 56 and laterally extending portions 57) in the front surface of the plate body 51, and resiliently deformable in the vertical direction and lateral direction.

A pair of the plate locked portions 58 are formed to project on end surfaces on both left and right sides of the plate body 51. Each plate locked portion 58 has a rectangular shape long in the vertical direction in the front view and is fittable into the plate locking portion 38 at the protection position. The vertically extending portion 56 of the thin portion 55 is arranged on a laterally inner side of each plate locked portion 58. Each plate locked portion 58 is displaceable laterally inward, accompanied by the resilient deformation of the vertically extending portion 56 of the thin portion 55.

A pair of the end side locked portions 59 are formed to project in both left and right end parts of the upper end surface of the plate body 51. Each end side locked portion 59 has a rectangular shape long in the lateral direction in the front view, and is fittable into each end side lock portion 36 at the connection position. As shown in FIG. 3, the front surface of the end side locked portion 59 is inclined rearward. The rear surface of the end side locked portion 59 is inclined forward. Left and right end surfaces of the end side locked portion 59 are arranged along the front-rear direction and vertical direction, and parallel to and in contact with or proximate to the left and right surfaces (surfaces laterally facing each other) of the inner wall of the end side lock portion 36 (see FIG. 1). The laterally extending portion 57 of the thin portion 55 is arranged on a vertically inner side of each end side lock portion 36. Each end side locked portion 59 is displaceable vertically inward, accompanied by the resilient deformation of the laterally extending portion 57 of the thin portion 55. Further, the end side locked portion 59 is fittable into the guide portion 32 of the upper wall 27 in the process of moving the moving plate 50.

As shown in FIG. 10, a pair of fitting projections 61 are formed to project at positions laterally inward of the respective end side locked portions 59 and laterally outward of a lateral center on the upper end surface of the plate body 51. Each fitting projection 61 is fit and arranged in a space formed between the guide rib 33 on the lateral central side of the receptacle 22 and the base portion 33 (see FIG. 4).

A pair of guided portions 62 are formed to project in both left and right end parts of the lower end surface of the plate body 51. The guided portion 62 is shaped similarly to the end side locked portion 59 and fittable into the guide portion 32 of the lower wall 28 as shown in FIG. 4.

As shown in FIGS. 3 and 11, the plate body 51 is formed with guiding portions 63 largely expanding from the rear ends of the insertion holes 54 to the rear surface of the plate body 51. The guiding portion 63 is formed from the plate body 51 to the protrusion 53. An upper end part of the guiding portion 63 is formed to cut the protrusion 53. As shown in FIG. 5, a base end part of the tab 92 is arranged inside the guiding portion 63 at the connection position.

A pair of the protrusions 53 are arranged at positions spaced apart in the vertical direction on the rear surface of the plate body 51. Each protrusion 53 projects over an entire width in the lateral direction on the front surface of the plate body 51. Each protrusion 53 is inserted and arranged in each recess 25.

As shown in FIGS. 9 and 10, a pair of the plate lock portions 52 are arranged at positions spaced apart in the lateral direction on the front surface of the plate body 51. Each plate lock portion 52 is inserted and arranged in each plate lock receiving portion 122 when the housing 20 and the mating housing 120 are connected (see FIG. 2).

As shown in FIG. 10, the upper and lower surfaces of each plate lock portion 52 are arranged along the lateral direction. As shown in FIG. 9, each plate lock portion 52 is in the form of a rectangular plate long in the front-rear direction in a plan view, and resiliently deformable in the vertical direction with the front surface of the plate body 51 as a fulcrum. A lock hole 64 is formed to penetrate through each plate lock portion 52 in the vertical direction (thickness direction of the plate lock portion 52). The lock hole 64 is in the form of a square or nearly square rectangular opening in the plan view. As shown in FIG. 5, the plate locked portion 123 is fittable into the lock hole 64.

### Functions of Connector 10

In assembling, the moving plate 50 is inserted into the receptacle 22 from font. In the process of inserting the moving plate 50, each guided portion 62 is fit and inserted into each guide portion 32 of the lower wall 28 and each end side locked portion 59 is inserted into each guide portion 32 of the upper wall 27 to guide the assembly of the moving plate 50. Further, with the vertically extending portion 56 of each thin portion 55 resiliently deformed, each plate locked portion 58 slides on the inner surface of each side wall 22 of the receptacle 22.

When the moving plate 50 is at the protection position, the vertically extending portion 56 of each thin portion 55 resiliently returns and each plate locked portion 58 is fit into each plate locking portion 38 from the laterally inner side. In this way, a movement of the moving plate 50 in the front-rear direction is restricted. As shown in FIG. 6, the plate body 51 is arranged in front of and away from the front surface of the housing body 21 (back surface of the receptacle 22) at the protection position. A tip part of the tab 92 of each terminal fitting 90 is positioned and inserted into each insertion hole 54 of the plate body 51.

When the moving plate 50 is at the protection position, the mating housing 120 is inserted into the receptacle 22 from front. Here, if an attempt is made to insert the mating housing 12 in an inclined posture into the receptacle 22, the mating housing 120 butts against a tip part of each plate lock portion 52 to restrict a connecting operation of the mating housing 120. At this time, the tip part of the tab 92 of each terminal fitting 90 is set not to interfere with the mating housing 120 in the inclined posture.

If the mating housing 120 is inserted in a proper posture into the receptacle 22, each plate lock portion 52 enters each plate lock receiving portion 122. The mating housing 120 contacts the front surface of the plate body 51, the moving plate 50 is pressed by the mating housing 120 and the locking of each plate locked portion 58 and each plate locking portion 38 is released. As the operation of connecting the mating housing 120 to the housing 20 proceeds, the moving plate 50 moves toward the connection position inside the receptacle 22 together with the mating housing 120.

Immediately before the moving plate 50 reaches the connection position, the lock projection 126 of the central side locked portion 124 slides on the inclined surface of the inner surface of the base portion 34 and the arm portion 125 is resiliently deformed downward (in the height direction). Further, the respective end side locked portions 59 slide on the ribs 37 and the laterally extending portions 57 of the respective thin portions 55 are resiliently deformed downward.

When the moving plate 50 reaches the connection position, the arm portion 125 resiliently returns, the lock projection 126 is fit into the central side lock portion 35 from below, and the housing 20 and the mating housing 120 are held in the connected state on a widthwise central side (see FIG. 2). Similarly, the laterally extending portions 57 of the respective thin portions 55 resiliently return and the respective end side locked portions 59 are fit into the respective end side lock portions 36 from below (see FIGS. 3 and 4). Each plate lock portion 123 is fit into the lock hole 64 of each plate lock portion 52, and the moving plate 50 and the mating housing 120 are held in a state where relative displacements are restricted (see FIG. 5). Thus, the housing 20 and the mating housing 120 are held in the connected state also on both widthwise end sides.

When the housing 20 and the mating housing 120 are in the connected state, the tab 92 of each terminal fitting 90 is inserted to a proper depth into the connecting portion 191 of each mating terminal fitting 190 (see FIGS. 3 and 5) and each terminal fitting 90 and each mating terminal fitting 190 are electrically connected. The plate body 51 contacts the front surface of the housing body 21 and is arranged in a state sandwiched between the housing body 21 and the mating housing 120 inside the receptacle 22 (see FIGS. 2 and 3). The protrusions 53 are arranged to face the respective locking lances 24 from front inside the recesses 25.

If vibration is applied to the housing 20 and the mating housing 120 in the connected state, each wire W pulled out from the wire pull-out surface 26 of the housing 20 may shake in the width direction (see both arrows of FIG. 1). In the case of this embodiment, the vibration of each wire W can be received and a vibration force can be partially absorbed by locking the respective end side lock portions 36 located in the both left and right end parts in the connected state to the respective end side locked portions 59. Thus, the transfer of the vibration force to the central side lock portion 35 located in the lateral central side in the connected state can be significantly reduced. As a result, it can be avoided that a locked part of the central side lock portion 35 and the central side locked portion 124 becomes a shaking fulcrum of each wire W pulled out from the wire pull-out surface 26, and the rattling of the housing 20 with respect to the mating housing 120 can be suppressed.

As described above, the connector 10 of this embodiment is provided with the housing 20 connectable to the mating connector 100. The housing 20 includes the plurality of cavities 23 capable of accommodating the terminal fittings 90. The respective cavities 23 are arranged side by side in the width direction inside the housing 20. Further, the housing 20 includes the central side lock portion 35 located on the widthwise central side for holding the connected state to the mating connector 100 and the end side lock portions 36 located on the both widthwise end sides for holding the connected state to the mating connector 100. According to this configuration, when vibration in the width direction is applied to the connector 10, the vibration force can be partially received by the end side lock portions 36 located on the both widthwise end sides of the housing 20. Thus, it can be avoided that the central side lock portion 35 becomes a shaking fulcrum of the housing 20. In this way, the connected state of the housing 20 and the mating connector 100 can be held without rattling by the interaction of the central side lock portion 35 and the end side lock portions 36. As a result, the terminal fitting 90 can be prevented from receiving the vibration force of the wire W and being worn.

Further, in the case of this embodiment, the central side lock portion 35 and the central side locked portion 124 serving as a locking partner of the central side lock portion 35 are configured to be locked to each other in the height direction while being restricted from moving in the width direction. The end side lock portions 36 and the end side locked portions 59 serving as locking partners of the end side lock portions 36 are also configured to be locked to each other in the height direction while being restricted from moving in the width direction. According to this configuration, the rattling of the housing 20 in the width direction with respect to the mating connector 100 can be more reliably suppressed.

Further, in the case of this embodiment, the end side locked portions 59 are provided on the moving plate 50 to be arranged movably inside the receptacle 22 of the housing 20. Separately from the end side locked portions 59, the moving plate 50 includes the plate lock portions 52 to be locked to the mating connector 100 when the housing 20 and the mating connector 100 are in the connected state. According to this configuration, the mating connector 100 is locked to the moving plate 50 by the plate lock portions 52 and can be held in the connected state to the housing 20 via the end side locked portions 59 of the moving plate 50. In this way, a structure on the side of the housing 20 can be simplified.

Further, the pair of plate lock portions 52 are arranged in the moving plate 50 while being spaced apart in the width direction. According to this configuration, the rattling of the mating connector 100 in the width direction with respect to the moving plate 50 can be suppressed and a function of suppressing the rattling of the housing 20 with respect to the mating connector 100 can be ensured.

Further, in the case of this embodiment, the wire pull-out surface 26 is formed on the rear surface of the housing 20, each wire W connected to each terminal fitting 90 is pulled out rearward from the wire pull-out surface 26 and each end side lock portion 36 is arranged behind the central side lock portion 35. According to this configuration, when each wire W pulled out from the wire pull-out surface 26 of the housing 20 shakes in the width direction, the end side lock portions 36 located near each pulled-out wire W can more efficiently receive the vibration of each wire W than the central side lock portion 35. As a result, the rattling of the housing 20 in the width direction with respect to the mating connector 100 can be even more reliably suppressed.

### Other Embodiments of Present Disclosure

The embodiment disclosed this time should be considered illustrative in all aspects, rather than restrictive.

In the case of the above embodiment, one central side lock portion 35 is formed in the widthwise central part of the housing 20. However, a central side lock portion only has to be formed on a widthwise central side (not limited to a precise center position in the width direction) of a housing. For example, a pair of central side lock portions may be formed on both sides across a widthwise center of a housing.

In the case of the above embodiment, the pair of end side lock portions 36 are formed in the both widthwise end parts of the housing 20. However, end side lock portions only have to be formed on both widthwise end sides (parts near both widthwise ends except a widthwise central side) of a housing. For example, a plurality of end side lock portions may be formed at different distances from a widthwise center.

In the case of the above embodiment, each end side lock portion 36 is provided on the moving plate 50. However, each end side lock portion may be provided on a housing. If each end side lock portion is provided on the housing, each end side locked portion serving as a locking partner of each end side lock portion may be provided on a mating housing.

In the case of the above embodiment, the central side lock portion 35 is provided on the housing 20. However, a central side lock portion may be provided on a moving plate.

In the case of the above embodiment, the pair of plate lock portions 52 are arranged in the moving plate 50 while being spaced apart in the width direction. However, three or more plate lock portions may be arranged at intervals in the width direction in a moving plate.

In the case of the above embodiment, the central side lock portion 35 and the end side lock portions 36 have a recess shape (in particular, a hole shape) and the central side locked portion 124 and the end side locked portions 59 have a projection shape. However, a central side lock portion and end side lock portions may have a projection shape and a central side locked portion and end side locked portions may have a recess shape.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a housing connectable to a mating connector,
the housing including a plurality of cavities capable of accommodating terminal fittings,
the plurality of cavities being arranged side by side in a width direction intersecting a connection direction of the housing and the mating connector inside the housing, and
the housing including a central side lock portion located on a central side in the width direction for holding a connected state to the mating connector and end side lock portions located on both end sides in the width direction for holding the connected state to the mating connector.

2. The connector of claim 1, wherein:
the central side lock portion and a central side locked portion serving as a locking partner of the central side lock portion are locked while being restricted from moving in the width direction, and
the end side lock portions and end side locked portions serving as locking partners of the end side lock portions are locked while being restricted from moving in the width direction.

3. The connector of claim 2, wherein:
the end side locked portions are provided on a moving plate to be arranged movably inside a receptacle of the housing, and
the moving plate includes a plate lock portion to be locked to the mating connector when the housing and the mating connector are in the connected state, separately from the end side locked portions.

4. The connector of claim 3, wherein a plurality of the plate lock portions are arranged at intervals in the width direction in the moving plate.

5. The connector of claim 1, wherein:
the housing has a wire pull-out surface arranged to face rearward in a direction opposite to the connection direction to the mating connector and wires connected to the terminal fittings are pulled out rearward from the wire pull-out surface, and
the end side lock portions are arranged behind the central side lock portion.
